(19) United States
(12) Patent Application Publication
(10) Pub. No.: US 2024/0324062 A1
(43) Pub. Date: Sep. 26, 2024

(54) METHOD AND DEVICE FOR REDUCING POWER CONSUMPTION IN A WIRELESS COMMUNICATION SYSTEM

(71) Applicant: Samsung Electronics Co., Ltd., Gyeonggi-do (KR)

(72) Inventors: Min WU, Beijing (CN); Sa ZHANG, Beijing (CN); Feifei SUN, Beijing (CN)

(21) Appl. No.: 18/603,826

(22) Filed: Mar. 13, 2024

(30) Foreign Application Priority Data
Mar. 22, 2023 (CN) 202310289457.8

(51) Int. Cl. H04W 76/28; H04B 7/06; H04W 72/231

(52) U.S. Cl. CPC H04W 76/28; H04B 7/0626; H04W 72/231

(57) ABSTRACT

The disclosure relates to a fifth generation (5G) or sixth generation (6G) communication system for supporting a higher data transmission rate. Disclosed is a method performed by a user equipment (UE) in a communication system, including receiving a first configuration of a discontinuous reception (DRX), the first configuration including at least one of a first starting position, a first cycle length and a first onDuration length, performing the DRX based on the first configuration, determining a second configuration of the DRX after a cell discontinuous transmission (DTX) and/or cell DRX is enabled, the second configuration including at least one of a second starting position, a second cycle length and a second onDuration length, and performing the DRX based on the second configuration.

### CROSS REFERENCE TO RELATED APPLICATION

The present application claims priority to Chinese Patent Application No. 202310289457.8, which was filed in the China National Intellectual Property Administration on Mar. 22, 2023, the entire content of which is incorporated herein by reference.

### BACKGROUND

### 1. Field

The disclosure relates generally to the field of radio communication, and more particularly, to a method and device for reducing power consumption in a wireless communication system.

### 2. Description of Related Art

Fifth generation (5G) mobile communication technologies define broad frequency bands such that high transmission rates and new services are possible and can be implemented in sub 6 gigahertz (GHz) bands such as 3.5 GHz, and in above 6 GHz bands referred to as millimeter wave (mmWave) including 28 GHz and 39 GHz. In addition, it has been considered to implement sixth generation (6G) mobile communication technologies referred to as beyond 5G systems in terahertz (THz) bands, such as 95 GHz to 3THz bands, to realize transmission rates fifty times faster than 5G mobile communication technologies and ultra-low latencies one-tenth of 5G mobile communication technologies.

Since the outset of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, level 2 (L2) pre-processing, and network slicing for providing a dedicated network specialized to a specific service.

Discussions are ongoing regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There is also ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, it is expected that the number of devices that will be connected to communication networks will exponentially increase. Thus, it is anticipated that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In 5G communication systems, system network improvements are underway based on advanced small cell, cloud radio access network (RAN), ultra-dense network, device-to-device (D2D) communication, wireless backhaul, mobile network, cooperative communication, coordinated multi-points (CoMP), and reception-end interference cancellation, among other technologies.

In 5G systems, hybrid frequency shift keying (FSK) and quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In a wireless mobile communication system, UE power saving has remained a goal. While also important, network power saving has been less of a focus compared to UE power saving. Mobile communication base station power consumption accounts for about 60-70% of the operator's total power consumption. Thus, it is vital to reduce the power consumption of the communication base station and to maintain the reliability of the communication.

In the conventional art, base stations generally experience unnecessarily high usage of power. As such, there is a need in the art for a method and apparatus for reducing the power consumption of a communication base station and maintaining the reliability of the communication.

### SUMMARY

This disclosure has been made to address at least the above-mentioned problems and/or disadvantages and to provide at least the advantages described below.

Accordingly, an aspect of the disclosure is to provide a method and apparatus for reducing the power consumption of a communication base station and maintaining the reliability of the communication.

An aspect of the disclosure is to provide a communication method which enables a UE to be awakened in an active state of a cell discontinuous transmission (DTX) and/or cell discontinuous reception (DRX), thereby enabling the UE to be efficiently serviced by the cell.

In accordance with an aspect of the disclosure, a method performed by a UE in a communication system includes receiving a first configuration of a discontinuous reception (DRX), the first configuration including at least one of a first starting position, a first cycle length and a first onDuration length, performing the DRX based on the first configuration, determining a second configuration of the DRX after a cell discontinuous transmission (DTX) and/or cell DRX is enabled, the second configuration including at least one of a second starting position, a second cycle length and a second onDuration length, and performing the DRX based on the second configuration. Optionally, the first starting position and the second starting position are different, and/or, the first cycle length and the second cycle length are different, and/or, the first onDuration length and the second onDuration length are different.

In accordance with an aspect of the disclosure, a method performed by a base station in a communication system includes transmitting to a UE a first configuration for receiving a DRX, the first configuration including at least one of a first starting position, a first cycle length and a first onDuration length to enable the UE to perform the DRX based on the first configuration; after the cell and/or cell DRX is enabled, determining a second configuration of the DRX, the second configuration including at least one of a second starting position, a second cycle length and a second onDuration length, and performing the DRX based on the second configuration.

In accordance with an aspect of the disclosure, a user equipment includes a transceiver, and a processor, which is coupled to the transceiver and configured to perform the method of receiving a first configuration of a discontinuous reception (DRX), the first configuration including at least one of a first starting position, a first cycle length and a first onDuration length, performing the DRX based on the first configuration, determining a second configuration of the DRX after a cell discontinuous transmission (DTX) and/or cell DRX is enabled, the second configuration including at least one of a second starting position, a second cycle length and a second onDuration length, and performing the DRX based on the second configuration.

According to the various embodiments of the disclosure, the UE can wake up to perform the DRX in the active state of the cell DTX and/or cell DRX, thereby enabling the UE to be efficiently served by the cell, and providing communication reliability based on effectively reducing the power consumption of the communication base station to achieve the purpose of power saving at the base station side.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates an overall structure of a wireless network according to an embodiment;

FIG. 2A illustrates a transmission path according to an embodiment;

FIG. 2B illustrates a reception path according to an embodiment;

FIG. 3A illustrates a UE according to an embodiment;

FIG. 3B illustrates a base station according to an embodiment;

FIG. 4 illustrates a method performed by a UE according to an embodiment;

FIG. 5 illustrates a cell DTX/DRX with periodicity according to an embodiment;

FIG. 6 is a schematic diagram in which the duration of the active state of the UE DRX is outside the duration of the active state of the cell DTX/DRX according to an embodiment;

FIG. 7 illustrates shifting a starting position of a UE DRX cycle to be within the duration of the active state of the cell DTX/DRX by means of a preset rule according to an embodiment;

FIG. 8 illustrates a structure of an electronic device according to an embodiment;

FIG. 9 illustrates a structure of a UE according to an embodiment; and

FIG. 10 illustrates a structure of a base station according to an embodiment.

### DETAILED DESCRIPTION

The following description with reference to the accompanying drawings is provided to assist in a comprehensive understanding of various embodiments of the disclosure. It includes various specific details to assist in that understanding but these are to be regarded as merely examples. Accordingly, those skilled in the art will recognize that various changes and modifications of the various embodiments described herein can be made without departing from the scope and spirit of the disclosure. In addition, descriptions of well-known functions and constructions may be omitted for the sake of clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the disclosure is provided for illustration purposes only and not for the purpose of limiting the disclosure.

Singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used herein includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure pertains. Such terms as those defined in a generally used dictionary are to be interpreted to have the meanings equal to the contextual meanings in the relevant field of art and are not to be interpreted to have ideal or excessively formal meanings unless clearly defined in the disclosure.

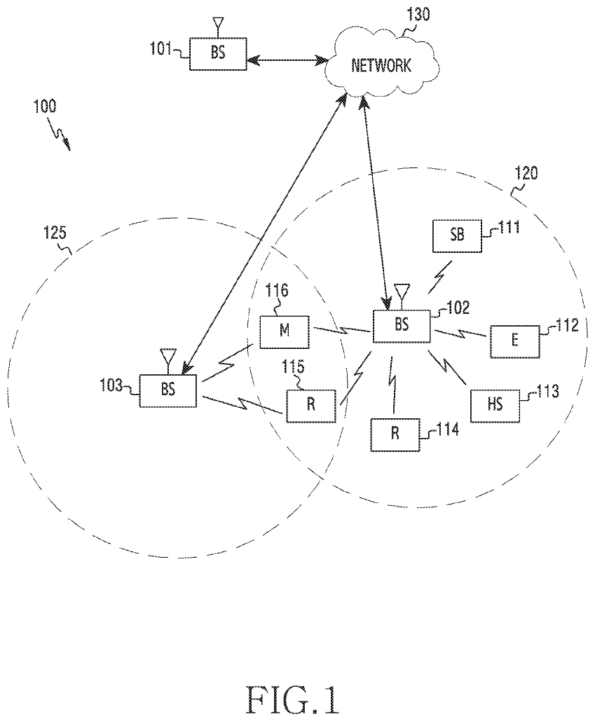

FIG. 1 illustrates an example wireless network 100 according to an embodiment.

Referring to FIG. 1, the wireless network 100 includes a gNodeB (gNB) 101, a gNB 102, and a gNB 103. The gNB 101 communicates with the gNB 102 and gNB 103. The gNB 101 also communicates with at least one Internet protocol (IP) network 130, such as the Internet, a private IP network, or other data network.

Depending on a type of the network, other well-known terms such as base station or access point can be used instead of gNodeB or gNB. For convenience, the terms gNodeB and gNB are used in this patent document to refer to network infrastructure components that provide wireless access for remote terminals. Depending on the type of the network, other well-known terms such as mobile station, user station, remote terminal, wireless terminal or user device can be used instead of UE. For convenience, the terms user equipment and UE are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a plurality of first UEs within a coverage area 120 of the gNB 102. The first plurality of UEs include a UE 111, which may be located in a small business (SB), a UE 112, which may be located in an enterprise (E), a UE 113, which may be located in a wireless fidelity (WiFi) hotspot (HS), a UE 114, which may be located in a first residence (R), a UE 115, which may be located in a second residence (R), a UE 116, which may be a mobile device (M), such as a cellular phone, a wireless laptop computer, a wireless PDA, etc. The gNB 103 provides wireless broadband access to the network 130 for a plurality of second UEs within the coverage area 125 of the gNB 103. The plurality of second UEs includes UE 115 and UE 116. Alternatively, one or more of gNBs 101-103 can communicate with each other and with UEs 111-116 using 5G, long term evolution (LTE), LTE-A, WiMAX or other advanced radio communication technologies.

The dashed lines show approximate ranges of the coverage areas 120 and 125, and the ranges are shown as approximate circles merely for illustration purposes. The coverage areas 120 and 125 may have other shapes, including irregular shapes, depending on configurations of the gNBs and changes in the radio environment associated with natural obstacles and man-made obstacles.

One or more of gNB 101, gNB 102, and gNB 103 include a 2D antenna array. Alternatively, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

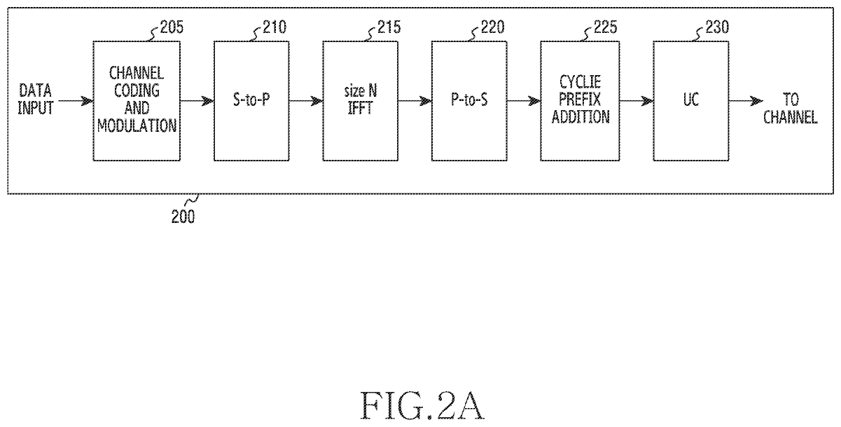

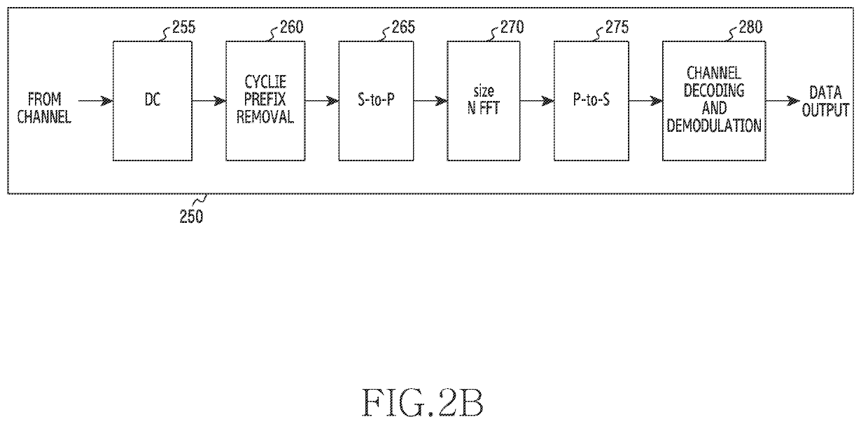

FIGS. 2A and 2B illustrate example wireless transmission and reception paths according to an embodiment.

The transmission path 200 is described as being implemented in a gNB, such as gNB 102, and the reception path 250 is described as being implemented in a UE, such as UE 116. However, it should be understood that the reception path 250 can be implemented in a gNB and the transmission path 200 can be implemented in a UE. Alternatively, the reception path 250 is configured to support codebook designs and structures for systems with 2D antenna arrays.

In FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. In FIG. 2B, the reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies low density parity check (LDPC) coding, and modulates the input bits such as by using quadrature phase shift keying (QPSK) or quadrature amplitude modulation (QAM)) to generate a sequence of frequency-domain modulated symbols. The S-to-P block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 multiplexes parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at the UE 116 after passing through the wireless channel, and operations in reverse to those at gNB 102 are performed at the UE 116. The down-converter 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from UEs 111-116 in the uplink. Similarly, each of the UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. Specifically, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B illustrate examples of types of transmission and reception paths that can be used in a wireless network. Any other suitable architecture can be used to support radio communication in a wireless network.

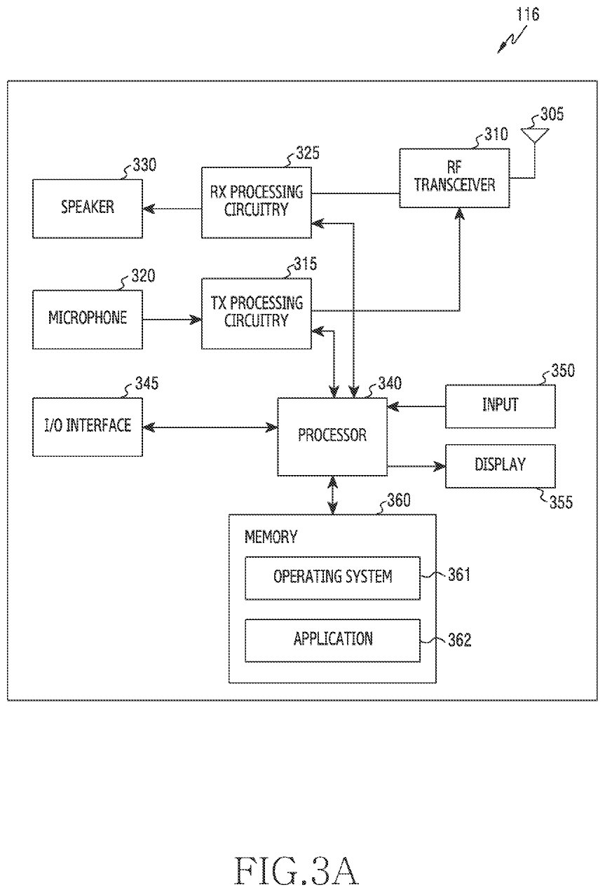

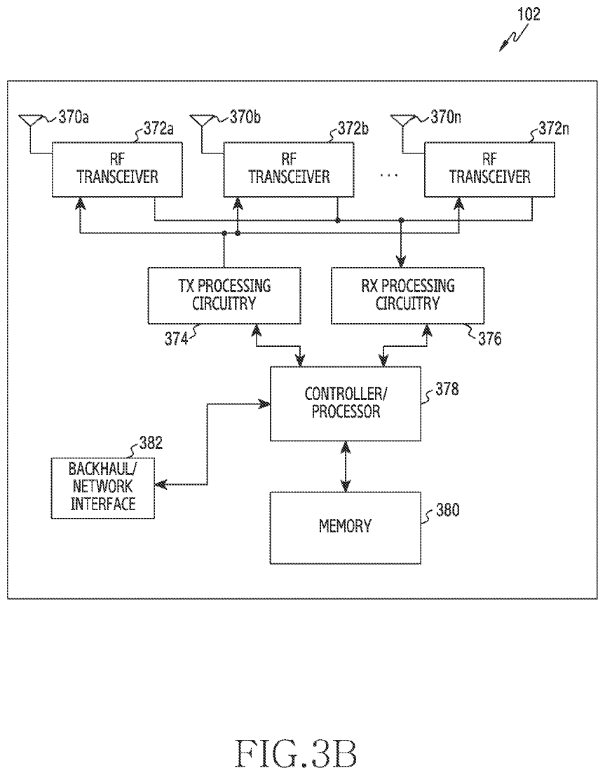

FIG. 3A illustrates an example UE 116 according to an embodiment.

The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted by the antenna 305.

The processor/controller 340 can include one or more processors or other processing devices and perform an OS 361 stored in the memory 360 to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. Alternatively, the processor/controller 340 includes at least one microprocessor or microcontroller.

The processor/controller 340 is also capable of performing other processes and programs residing in the memory 360, such as operations for channel quality measurement and reporting for systems with 2D antenna arrays. The processor/controller 340 can transport data into or out of the memory 360 as required by an execution process. Alternatively, the processor/controller 340 is configured to perform the application 362 based on the OS 361 or in response to signals received from the gNB or the operator. The processor/controller 340 is also coupled to an I/O interface 345 which provides the UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. The processor/controller 340 can be divided into a plurality of processors, such as one or more central processing units (CPUs) and one or more graphics processing units (GPUs). Although FIG. 3A illustrates that the UE 116 is configured as a mobile phone or a smart phone, UEs can be configured to operate as other types of mobile or fixed devices.

FIG. 3B illustrates an example the gNB 102 according to an embodiment. The gNB 102 shown in FIG. 3B is for illustration only, and other gNBs of FIG. 1 can have the same or similar configuration. However gNB has various configurations, and FIG. 3B does not limit the scope of the disclosure to any specific gNB implementation. It should be noted that the gNB 101 and the gNB 103 can include the same or similar structures as the gNB 102.

In FIG. 3B, gNB 102 includes a plurality of antennas 370a-370n, a plurality of RF transceivers 372a-372n, a transmission (TX) processing circuit 374, and a reception (RX) processing circuit 376. One or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from antennas 370a-370n, such as a signal transmitted by the UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted by at least one of the antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level radio communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. Alternatively, the controller/processor 378 includes at least one microprocessor or microcontroller.

The controller/processor 378 is also capable of performing programs and other processes residing in the memory 380, such as a basic OS. The controller/processor 378 can also support channel quality measurement and reporting for systems with two-dimensional (2D) antenna arrays. Alternatively, the controller/processor 378 supports communication between entities such as web RTCs. The controller/processor 378 can transport data into or out of the memory 380 as required by an execution process.

The controller/processor 378 is also coupled to the backhaul or network interface 382 which enables the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM, while another part of the memory 380 can include a flash memory or other ROMs. A plurality of instructions, such as the BIS algorithm, are stored in the memory and are configured to cause the controller/processor 378 to perform the BIS process and decode the received signal after subtracting at least one interference signal determined by the BIS algorithm.

The transmission and reception paths of the gNB 102 (implemented using RF transceivers 372A-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. The access point can include many backhaul or network interfaces 382, and the controller/processor 378 can support routing functions to route data between different network addresses. Although shown as including a single instance of the TX processing circuit 374 and a single instance of the RX processing circuit 376, the gNB 102 can include multiple instances of each (such as one for each RF transceiver).

Embodiments of the disclosure provide a communication method, which is a relevant method for power saving at a base station from the perspective of cell discontinuous transmission and/or discontinuous reception. Reducing the power consumption of a communication base station is of great significance to a communication operator in realizing the goal of energy conservation and emission reduction, and the reduction of the power consumption of the base station can reduce the amount of heat generated by the equipment, and the corresponding power consumption of the air conditioner will be reduced accordingly, thereby reducing the electricity expenditure of the operator.

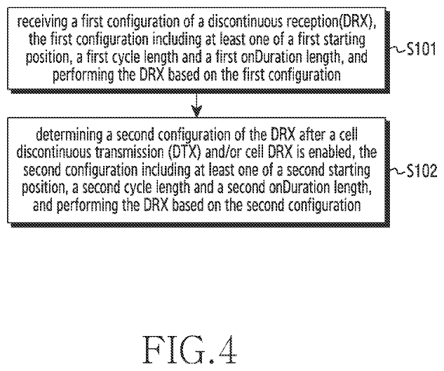

FIG. 4 illustrates a method performed by a UE according to an embodiment:

Referring to FIG. 4, in step S101 a first configuration of a DRX is received by the UE, the first configuration including at least one of a first starting position, a first cycle length and a first onDuration length, and the DRX is performed based on the first configuration.

The DRX refers to a DRX at the UE side. The UE is configured to achieve power saving through DRX, which may be referred to as a UE DRX hereinafter for the purpose of distinguishing from a cell DTX and a cell DRX.

The first starting position of the DRX is a first starting position of a DRX cycle, and the first onDuration length of the DRX is a duration of an active state of the DRX within a DRX cycle.

In step S102, the UE determines a second configuration of the DRX after a cell discontinuous transmission (DTX) and/or cell DRX is enabled, the second configuration including at least one of a second starting position, a second cycle length and a second onDuration length, and the UE performs the DRX based on the second configuration.

The cell performs discontinuous transmission and/or discontinuous reception for the purpose of power saving at the base station. Specifically, the cell DTX may be configured individually, the cell DRX may be configured individually, or both the cell DTX and the cell DRX may be configured, e.g., individually configured or combined into a single configuration, etc., for the purpose of power saving at the base station.

For ease of description, the cell DTX and/or cell DRX may be abbreviated as cell DTX/DRX, i.e., “/” and “and/or” may be interchangeable, i.e., the cell DTX/DRX may also include an independently configured cell DTX, may include an independently configured cell DRX, may include both the cell DTX and the cell DRX configured independently of each other, or may include the cell DTX and the cell DRX configured in combination.

In addition, the base station and the cell served by the base station have a one-to-one correspondence, so that the cell DTX may also be understood as the base station DTX, and the cell DRX may also be understood as the base station DRX.

The configuration of the cell DTX and/or cell DRX may be configured by UE-specific radio resource control (RRC) signaling.

The configuration of the cell DTX/DRX is enabled and becomes effective after the UE receives the configuration of the cell DTX/DRX.

Alternatively, the configuration of the cell DTX/DRX may not be immediately received, and the configured cell DTX/DRX may need to be enabled or disabled, e.g., by the downlink control information (DCI) or the media access control (MAC) control element (CE). The cell DTX/DRX configured by RRC signaling becomes effective only after the UE receives the signaling used for activating the configuration of the cell DTX/DRX.

Assuming that the activation/de-activation signaling for the cell DTX/DRX is carried by the MAC CE, the DCI used for scheduling this MAC CE may be scrambled using a cell-radio network temporary identity (C-RNTI), or other RNTI values corresponding to multicast/broadcast transmissions, the UE confirms that the cell DTX/DRX is enabled starting at the preset interval position after transmitting the hybrid automatic repeat request (HARQ) feedback corresponding to the MAC CE. Alternatively, assuming that the activation/de-activation signaling for the cell DTX/DRX is carried by a cell common DCI or UE group DCI, which is scrambled by using a dedicated RNTI value, the UE confirms that the cell DTX/DRX is enabled starting at a preset interval position after reception of the DCI.

Herein, for ease of description, whether the cell DTX/DRX is configured and enabled may be abbreviated as whether the cell DTX/DRX is configured/enabled, i.e., the cell DTX/DRX is configured/enabled indicates that the cell DTX/DRX is configured and activated, and the cell DTX/DRX not is configured/enabled indicates that the cell DTX/DRX is not configured, or is configured but not enabled, etc.

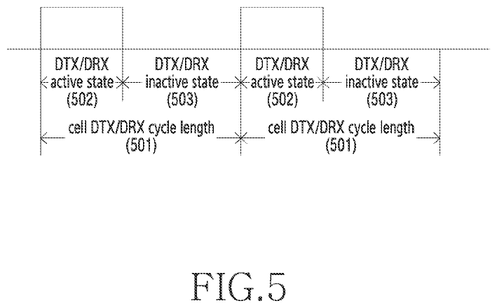

FIG. 5 illustrates a cell DTX/DRX with periodicity according to an embodiment.

In FIG. 5, the cell DTX/DRX cycle length 501 may include an active state 502 and an inactive state 503. In the inactive state, there is a restriction on the transmitting behavior and/or the receiving behavior of the cell, and in the active state, there are no constraints on the transmitting behavior and/or the receiving behavior of the cell. The active state of the cell DTX/DRX may also be referred to as the cell is turned on (ON), an active time, an active period, a working state, a non-power-saving state, or an active state, etc., and the inactive state of the cell DTX/DRX may also be referred to as the cell is turned off (OFF), a deactivated state, an inactive time, an inactive period, a sleep state, a hibernation state, a power-saving state, or an inactive state.

Herein, for ease of description, the active state of the cell DTX and/or cell DRX may be referred to as the cell DTX/DRX active state, which may refer to the cell DTX active state, the cell DRX active state, the cell DTX active state, the cell DRX active state, or the active state of the cell DTX and the cell DRX configured in combination. Similarly, the inactive state of the cell DTX and/or cell DRX may be referred to as the cell DTX/DRX inactive state, the cell DTX inactive state, the cell DRX inactive state, the cell DTX inactive state and the cell DRX inactive state, or the inactive state of the cell DTX and the cell DRX configured in combination.

The configuration of the cell DTX/DRX has a periodicity, and each cycle of the cell DTX/DRX includes a period of time in the active state and another period of time in the inactive state, as shown in FIG. 5.

In the cell DTX/DRX active state, there is no restriction on the cell transmitting behavior and receiving behavior, and correspondingly, there is no restriction on the UE transmitting behavior and receiving behavior, but in the cell DTX/DRX inactive state, there is a restriction on the cell transmitting behavior and receiving behavior. Thus, there are constraints on the UE transmitting behavior and receiving behavior.

When the DTX/DRX of a cell is determined to be in an inactive state, then the UE has at least one of the following restrictive behaviors on this cell:
1. the physical downlink control channel (PDCCH) on this cell is not monitored;
2. the PDCCH associated with this cell on other cells is not monitored;
3. a downlink shared channel (DL-SCH) on this cell is not received.

For the current symbol no, if at 4 milliseconds (ms) prior to the symbol no, the DTX/DRX of a cell is determined not to be in an active state (i.e., is in an inactive state) when the conditions for determining the active states of all cell DTX/DRX are considered, then the UE's behavior for the current symbol no on the current cell is restricted, e.g., at least one of the following UE-restricted behaviors is in effect:
1. at least one of periodic sounding reference signal (SRS), semi-persistent SRS, and aperiodic SRS on this cell is not transmitted;
2. at least one of periodic channel state information (CSI), semi-persistent CSI, or aperiodic CSI on this cell is not reported;
3. the CSI associated with this cell, including at least one of periodic CSI, semi-persistent CSI, and aperiodic CSI is not reporting on other cells;
4. It is determined whether to report at least one of the periodic CSI, the semi-persistent CSI, and the aperiodic CSI on this cell based on a high-layer signaling configuration, wherein the layer1-reference signal received power (L1-RSRP) and the other CSIs, may be configured whether or not they can be transmitted, respectively, by a parameter;
5. HARQ feedback on this cell is not transmitted;
6. It is determined whether to transmit the corresponding HARQ feedback on this cell based on the configuration of the high-layer signaling, and/or the priority of the physical downlink shared channel (PDSCH);
7. the HARQ feedback associated with this cell on other cells is not transmitted;
8. It is determined whether to transmit the HARQ feedback associated with this cell on other cells based on the configuration of the high-layer signaling, and/or the priority of the PDSCH;
9. scheduling request (SR) on this cell is not transmitted;
10. It is determined whether to transmit the SR on this cell based on the configuration of high-layer signaling, and/or an SR resource configuration;
11. a physical uplink control channel (PUCCH) on this cell is not transmitted;
12. an uplink shared channel (UL-SCH) on this cell is not transmitted;
13. It is determined whether to transmit Type 1 CG-PUSCH and/or Type 2 CG-PUSCH on this cell based on the configured grant physical uplink shared channel (CG-PUSCH); and
14. a physical random access channel (PRACH) or MsgA (first step of a two-step random access process) on this cell is not transmitted;

The cycle length of the cell DTX/DRX, the starting position of the cell DTX/DRX cycle, the duration of the cell DTX/DRX active state within a cell DTX/DRX cycle (which may be referred to as the onDuration of the cell DTX/DRX), and so on, may be semi-statically configured by high-layer signaling. That is, the configuration of the periodic cell DTX/DRX includes at least one of a parameter cycle for determining the cycle length, a parameter slotOffset for determining the starting position (e.g., time slot) of a cycle, and a parameter onDuration for determining the duration of the active state within the cycle. Herein, the onDuration refers to the duration of active state, and the onDuration length refers to the length of the duration of active state.

Herein, a UE is configured with a UE DRX. When the cell DTX/DRX is not configured/enabled, the UE determines at least one of the first starting position, the first cycle length, and the first onDuration length of the UE DRX based on high-layer configuration signaling of the UE DRX.

When the cell DTX/DRX is configured/enabled, the UE newly determines at least one of a second starting position, a second cycle length, and a second onDuration length of the DRX to achieve alignment of the UE DRX and the cell DTX/DRX.

The first configuration of the DRX and the second configuration of the DRX may be partially or completely different. That is, the first starting position and the second starting position are different, and/or the first cycle length and the second cycle length are different, and/or the first onDuration length and the second onDuration length are different.

Alignment indicates that the second cycle length of the DRX is an integer multiple of the cycle length of the cell DTX and/or cell DRX; and/or that the second starting position of the DRX is within the onDuration of the cell DTX and/or cell DRX; and/or that the second onDuration of the DRX is within the onDuration of the cell DTX and/or cell DRX.

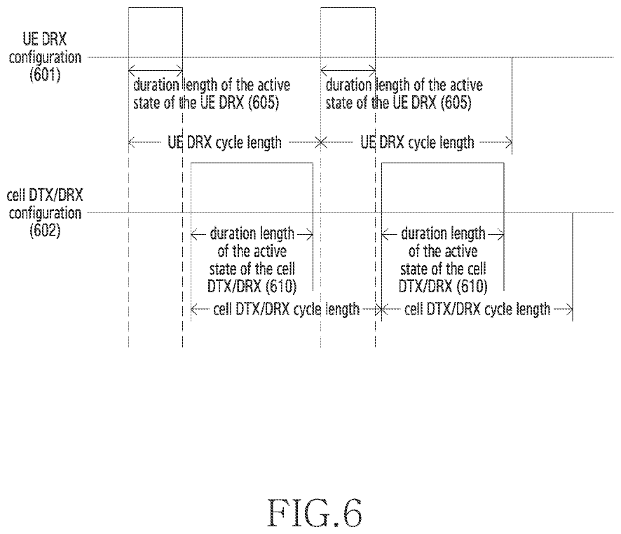

FIG. 6 is a schematic diagram in which the duration of the active state of the UE DRX is outside the duration of the active state of the cell DTX/DRX according to an embodiment.

In FIG. 6, since the cell DTX/DRX configuration 602 is used for power saving at the base station side and the UE DRX configuration 601 is used for power saving at the UE side, when a UE is configured with both a DRX at the UE side as well as a cell DTX/DRX, the cell DTX/DRX configuration 602 and the UE DRX configuration 601 satisfy the alignment principle, which can prevent a duration of the active state of the UE DRX 605 from being outside the duration of the active state of the cell DTX/DRX 610 and cause the UE not to wake up in the active state of the cell DTX/DRX and lose service by the cell, as shown in FIG. 6.

To wake up the UE in the active state of the cell DTX/DRX during each DRX cycle, the ideal state is to configure the duration of the active state of the UE DRX within the duration of the active state of the cell DTX/DRX and configure the cycle length of the UE DRX to be a multiple of the cycle length of the cell DTX/DRX. However, in the actual system such a configuration is more restrictive for resource usage.

When the configuration of the cell DTX/DRX is not enabled, the base station may also serve some UEs outside the duration of the active state of the cell DTX/DRX, i.e., the duration of the active state of these UE DRXs may be configured outside the duration of the active state of the cell DTX/DRX. When the cell DTX/DRX is enabled, these UEs that were originally configured to receive service outside the duration of the active state of the cell DTX/DRX are moved to within the duration of the active state of the cell DTX/DRX to satisfy the alignment principle of the UE DRXs of these UEs with the cell DTX/DRX.

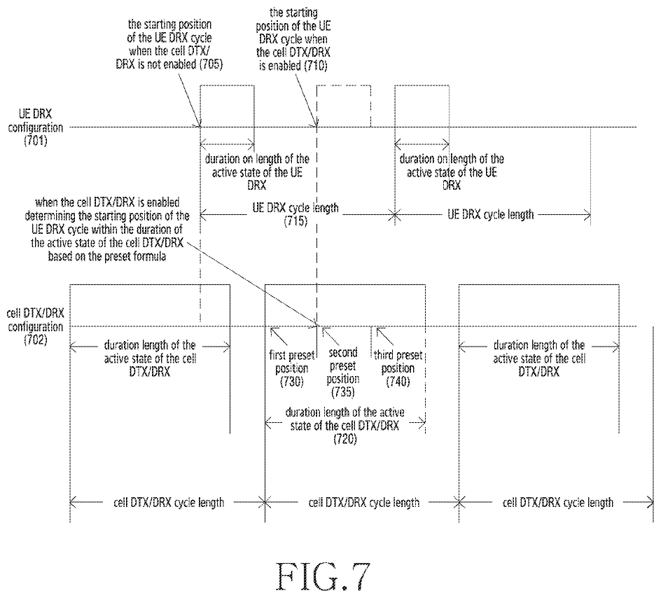

FIG. 7 illustrates shifting a starting position of a UE DRX cycle to be within the duration of the active state of the cell DTX/DRX by means of a preset rule according to an embodiment.

Specifically, FIG. 7 illustrates the alignment of the UE DRX configuration 701 and the cell DTX/DRX configuration 702 after the cell DTX/DRX is enabled. The starting position of the UE DRX is shifted within the duration of the active state of the cell DTX/DRX by a preset rule.

That is, when the cell DTX/DRX is not configured/enabled, the UE determines a first starting position of the UE DRX 705 according to the high-layer configuration parameters of the UE DRX. The first starting position of the UE DRX 705 is also the starting position of the duration of the active state within the UE DRX cycle 715. When the cell DTX/DRX is configured/enabled, the second starting position of the UE DRX 710 is determined by a preset rule to achieve the alignment of the UE DRX and the cell DTX/DRX.

Specifically, determining the second starting position of the DRX in step S102 of FIG. 4 may include determining the starting position of the cell DTX and/or cell DTX as the second starting position of the UE DRX.

Alternatively, one of a plurality of preset positions 730, 735, 740 within the onDuration of the cell DTX and/or cell DRX 720 is determined as the second starting position of the DRX 710, wherein the plurality of preset positions 730, 735, 740 within the onDuration of the cell DTX and/or cell DRX 720 have the same interval. the onDuration of the cell DTX and/or cell DTX is divided into N preset time periods, and the plurality of preset positions within the onDuration of the cell DTX and/or cell DRX corresponds to the starting positions of the N preset time periods.

The UE may determine one of the plurality of preset positions 730, 735, 740 within the duration of the active state of the cell DTX/DRX as the starting position of the UE DRX according to a preset formula.

Determining one of the plurality of preset positions within the onDuration of the cell DTX and/or cell DRX 720 as the second starting position of the DRX 710 may include determining the i+1st preset position within the onDuration of the cell DTX and/or cell DRX as the second starting position of the DRX, according to the number N of preset positions within the onDuration of the cell DTX and/or cell DRX, and a preset parameter, based on Equation (1) as follows.

$$i = ( parameter ) \% N \qquad ( 1 )$$

In Equation (1), the first preset position within the onDuration of the cell DTX and/or cell DRX is a starting position of the cell DTX and/or cell DRX.

The interval (or the length of the preset time period) between the preset positions within the onDuration of the cell DTX and/or cell DRX is determined in at least one of the following manners:
1. The interval is pre-configured by high-layer signaling;
2. The interval is a first onDuration length of the DRX;
3. The interval is a second onDuration length of the DRX.

The number of preset positions (or preset time periods) within the onDuration of the cell DTX and/or cell DRX (i.e., the value of N) is determined in at least one of the following manners:
1. The number of preset time periods is pre-configured by high-layer signaling;
2. The number of preset time periods is determined according to the ratio of the onDuration length of the cell DTX and/or cell DRX to the reference onDuration length of the DRX in Equation (2) as follows.

$$N = ⌈ Cell\_DTXDRX \_onDuration / Reference\_onDuration ⌉ \qquad ( 2 )$$

In Equation (2), Cell_DTXDRX_onDuration denotes the onDuration length of the cell DTX and/or cell DRX, and Reference_onDuration denotes the reference onDuration length. The reference onDuration length Reference_onDuration may be pre-configured, e.g., pre-configured by high-layer signaling.

3. The number of preset time periods is determined according to a ratio of the onDuration length of the cell DTX and/or cell DRX to the first onDuration length in Equation (3) as follows.

$$N = ⌈ Cell\_DTXDRX \_onDuration / UE\_DRX \_onDuration \_ 1 ⌉ \qquad ( 3 )$$

In Equation (3), Cell_DTXDRX_onDuration denotes a onDuration length of active state of the cell DTX and/or cell DRX, and UE_DRX_onDuration_1 denotes a first onDuration length of the DRX.

4. The number of preset time periods is determined according to a ratio of the onDuration length of the cell DTX and/or cell DRX to the second onDuration length in Equation (4), as follows.

$$N = ⌈ Cell\_DTXDRX \_onDuration / UE\_DRX \_onDuration \_ 2 ⌉ \qquad ( 4 )$$

In Equation (4), Cell_DTXDRX_onDuration denotes the onDuration length of the cell DTX and/or cell DRX, and UE_DRX_onDuration_2 denotes the second onDuration length of the DRX.

The result i calculated by the formula corresponds to the i+1st preset position within the duration of the active state of the cell DTX/DRX, i.e., the second starting position of the UE DRX is determined as the i+1st preset position. For example, assuming i=0, then the starting position of the UE DRX is determined to be the starting position of the cell DTX/DRX; assuming i=1, then the starting position of the UE DRX is determined to be the 2nd preset position within the cell DTX/DRX cycle.

The preset parameter is pre-configured by high-layer signaling or is determined based on at least one of:
1. a C-RNTI value of the UE, i.e., Parameter=C-RNTI;
2. a UE identity value of the UE, i.e., Parameter=UE_ID;
3. a temporary mobile station identity (TMSI) value of the UE, which is a parameter used by the UE to determine the paging frame and is at least one of 5G-S-TMSI %1024, 5G-S-TMSI %16384;
4. an international mobile station identity (IMSI) value of the UE, also a parameter used by the UE to determine the paging frame and is at least one of IMSI % 1024, IMSI % 4096, IMSI % 16384;
5. The preset parameter is pre-configured by UE-specific RRC signaling.

In another optional implementation, determining one of the plurality of preset positions within the onDuration of the cell DTX and/or cell DRX as the second starting position of the DRX may also include:

determining the jth preset position within the onDuration of the cell DTX and/or cell DRX as the second starting position of the DRX, based on the following Equation (5), according to the number N of preset positions within the onDuration of the cell DTX and/or cell DRX, and the preset parameter.

$$j = ( parameter ) \% N + 1 \qquad ( 5 )$$

In Equation (5), each parameter is described in the above description of the previous Equations and will not be repeated herein.

Determining one of the plurality of preset positions within the onDuration of the cell DTX and/or cell DRX as the second starting position of the DRX may also include directly indicating one of the plurality of preset positions as the second starting position of the DRX via the MAC CE or DCI, e.g., the UE receives a position index of one of the plurality of preset positions indicated by the MAC CE or DCI, and uses the preset position corresponding to the position index as the second starting position of the DRX.

In addition to shifting the starting position of the UE DRX to achieve the alignment between the UE DRX and the cell DTX/DRX, another optional implementation is provided for the alignment of the UE DRX and the cell DTX/DRX after the cell DTX/DRX is enabled: correcting a cycle length of the UE DRX to achieve the alignment of the UE DTX with the cell DTX/DRX.

Specifically, determining the second cycle length of the DRX in step S102 of FIG. 4 may include determining the second cycle length of the DRX according to the cycle length of the cell DTX and/or cell DRX. The UE may correct the cycle length of the UE DRX configured by the high-layer signaling according to the cycle length of the cell DTX and/or cell DRX.

The corrected cycle length of the UE DRX can be obtained by directly determining the cycle length of the cell DTX and/or cell DRX as the second cycle length of the DRX.

The corrected cycle length of the UE DRX can be obtained by determining the second cycle length of the DRX according to the cycle length of the cell DTX and/or cell DRX, and the first cycle length of the DRX.

The second cycle length of the DRX is determined based on at least one of the following formulas:

┌T_{ue_drx}/T_{cell_dtxdrx}┐*T_{cell_dtxdrx}

└T_{ue_drx}/T_{cell_dtxdrx}┘*T_{cell_dtxdrx},

where T_{cell_dtxdrx} is the cycle length of the cell DTX and/or cell DRX (which can be configured through high-layer signaling), T_{ue_drx} is the first cycle length of the DRX (i.e., the cycle length of the UE DRX determined through high-layer signaling configurations), and ┌·┐ is an upward rounded integer, and └·┘ is a downward rounding integer.

As another alternative for the alignment of the UE DRX and the cell DTX/DRX after the cell DTX/DRX is enabled, the duration of the active state of the DRX is adjusted to achieve the alignment between the UE DRX and the cell DTX/DRX.

Specifically, determining the second onDuration length of the DRX in step S102 of FIG. 4 may include determining the second onDuration length according to the onDuration length of the cell DTX and/or cell DRX. That is, the UE may adjust the duration of the active state of the UE DRX configured by the high-layer signaling according to the onDuration length of the cell DTX and/or cell DRX.

The adjusted duration of the active state of the UE DRX can be obtained by directly determining the onDuration length of the cell DTX and/or cell DRX as the second onDuration length of the DRX.

Alternatively, the adjusted duration of the active state of the UE DRX can be obtained by determining the second onDuration length of the DRX according to the ratio of the onDuration length of the cell DTX and/or cell DRX to M, M is a positive integer, and the value of M is predefined or pre-configured.

After the cell DTX/DRX is configured/enabled, the application of the above predefined rules to change the second configuration of the UE DRX by the UE is permitted (enabled) by the network through signaling. The network instructs the UE whether to change the second configuration of the UE DRX by using the above predefined rules through UE-specific RRC signaling, MAC CE, or DCI, for example, the cycle length, the starting position of the cycle, the onDuration, etc. If the UE receives the corresponding enable signaling from the base station, the second configuration is determined based on the above preset rules; otherwise, the first configuration determined according to the high-layer configuration parameters of the UE DRX continues to be applied.

The execution process of step S101 and step S102 in FIG. 4 may also be regarded as the base station configuring the first configuration and the second configuration for the UE.

Alternatively, before the cell DTX and/or cell DRX is enabled, the UE performs the DRX based on the first configuration by default. After the cell DTX and/or cell DRX is enabled, the UE performs the DRX based on the second configuration by default.

That is, if the cell DTX/DRX is not configured/enabled, the UE applies a first set of UE DRX parameters (i.e., the first configuration) therein to determine a cycle length of the UE DRX, a starting position of the cycle, and a duration of the active state within the cycle.

If the cell DTX/DRX is configured/enabled, the UE applies a second set of UE DRX parameters (i.e., the second configuration) therein to determine a cycle length of the UE DRX, a starting position of the cycle, and a duration of the active state within the cycle. The second configuration satisfies alignment requirements for the UE DRX and the cell DTX/DRX. For example, an alignment requirement for the cycle are met (e.g., the cycle length of the UE DRX should be an integer multiple of the cycle length of the cell DTX/DRX), and/or an alignment requirement for the starting position of the cycle is met (e.g., the starting position of the cycle of the UE DRX should be within a duration of the active state of the cell DTX/DRX), and/or an alignment requirement for the duration is met (the duration of the active state of the UE DRX should be within the duration of the active state of the cell DTX/DRX).

Alternatively, the base station configures two sets of UE DRX parameters for the UE, and the network activates (enables) one of the two sets via signaling such as UE-specific RRC signaling, MAC CE, or DCI to achieve alignment of the UE DRX and the cell DTX/DRX.

For example, in step S102, determining the second configuration of the DRX may include receiving the second configuration of the DRX indicated by RRC signaling.

As another example, after the cell DTX and/or cell DRX is enabled, the UE receives first information indicating the application of the first configuration or the second configuration via the MAC CE or DCI, and performs the DRX based on the DRX configuration corresponding to the first information.

The above two UE DRX configurations may be configured separately, e.g., parameters such as a cycle length of the UE DRX, a starting position of the cycle, and a duration of the active state within the cycle are configured separately. Alternatively, the above two UE DRX configurations may share certain parameters, e.g., at least one of the parameters of the cycle length of the UE DRX, the starting position of the cycle, and the duration of the active state within the cycle may be shared.

In an optional implementation for the alignment of the UE DRX and the cell DTX/DRX after the cell DTX/DRX is enabled, the network adjusts certain parameters of the UE DRX via dynamic signaling (e.g., a UE group DCI) to achieve the alignment of the UE DRX and the cell DTX/DRX.

Specifically, the method of FIG. 4 may further include receiving (dynamic) signaling for indicating the second configuration. That is, step S102 of FIG. 4 may include receiving second information related to the DRX indicated by the MAC CE or DCI, and determining the second configuration of the DRX based on the second information.

Herein, the UE monitors the dynamic signaling even if the UE DRX is in an inactive state. The UE may monitor the dynamic signaling within a preset time window before the starting position of the next UE DRX cycle. Alternatively, the UE monitors the dynamic signaling as long as the cell DTX/DRX is in an active state and the UE DRX is in an inactive state.

The second information is used to indicate at least one of an offset of the second starting position of the DRX relative to the first starting position of the DRX, a second cycle length of the DRX, and a second onDuration length of the DRX.

Specifically, the network adjusts the position of the UE to start the onDuration timer drx-onDurationTimer at the next UE DRX cycle by dynamic signaling. The network may indicate the UE to adjust forward or backward relative to the existing starting position of the drx-onDurationTimer (i.e., the first starting position) by an amount of the adjustment (or an offset the second starting position relative to the first starting position) may be predefined, pre-configured by high-layer signaling, or indicated together by such dynamic signaling.

The MAC CE or DCI includes a field for indicating the above offset. That is, in step S102, after the cell DTX and/or cell DRX is enabled, the MAC CE or DCI is received, and at least one of the second starting position, the second cycle length, and the second onDuration length of the DRX is determined according to the field included in the MAC CE or DCI for indicating the above offset.

Similarly, the dynamic signaling may also adjust the cycle of the UE DRX, or the size of the drx-onDurationTimer, etc. to achieve the alignment of the UE DRX and the cell DTX/DRX, i.e., the MAC CE or DCI directly includes the field for indicating at least one of the second cycle length and the second onDuration length. That is, in step S102, after the cell DTX and/or cell DRX is enabled, the MAC CE or DCI is received, and the second configuration of the DRX is determined according to the field included in the MAC CE or DCI for indicating at least one of the second cycle length and the second onDuration length of the DRX.

The signaling that activates the configuration of the cell DTX and/or cell DRX and the signaling that carries the first information or the second information related to the DRX may be identical signaling.

The MAC CE or DCI further includes a field for activating the configuration of the cell DTX and/or cell DRX. That is, in step S102, the MAC CE or DCI is received to determine that the cell DTX and/or cell DRX is enabled according to the field for activating the configuration of the cell DTX and/or cell DRX in the MAC CE or DCI. Thus, the second configuration of the DRX is determined according to the field included in the MAC CE or DCI for indicating at least one of the above offsets or at least one of the second cycle length and the second onDuration length of the DRX.

After the cell DTX/DRX is configured/enabled, the second configuration of the DRX based on the at least one of the above implementations is required in at least one of the following cases:
1. During at least one cycle of the DRX, the first starting position is outside the onDuration length of the cell DTX and/or cell DRX, i.e., the starting position of the UE DRX cycle as determined by the high-layer configuration is outside the duration of active state of the cell DTX/DRX in some UE DRX cycle. Alternatively, the starting position of the UE DRX cycle as determined by the high-layer configuration is outside the duration of active state of the cell DTX/DRX in each UE DRX cycle.
2. During at least one cycle of the DRX, a length of overlap of the first onDuration with the onDuration of the cell DTX and/or cell DRX is less than a preset time length, i.e., a length of overlap of the duration of the active state of the UE DRX, determined by the high-layer signaling configuration, with the duration of the active state of the cell DTX/DRX is less than a preset time length;
3. During at least one cycle of the DRX, the first onDuration does not overlap with the onDuration of the cell DTX and/or cell DRX, i.e., the duration of the active state of the UE DRX cycle as determined by the high-layer signaling configuration does not overlap with the duration of the active state of the cell DTX/DRX cycle.

In the current system, the UE is configured with a plurality of serving cells, which may correspond to the same UE DRX configuration. These multiple serving cells are controlled by the same UE DRX mechanism, and the same state of the UE DRX will be applied to these serving cells at the same time, but these serving cells may have different cell DTX/DRX configurations. In such a case, a problem occurs in that one UE DRX configuration needs to be aligned with multiple cell DTX/DRX configurations.

Thus, when the UE has a plurality of serving cells, the cell DTX and/or cell DRX associates with a primary cell (PCell) among the plurality of serving cells. That is, the UE DRX only needs to be aligned with the cell DTX/DRX of the PCell. For example, the configuration parameters of the cell DTX/DRX of the PCell should satisfy the requirements for alignment with the UE DRX, e.g., to satisfy the requirements for alignment of the cycle (e.g., the cycle length of the UE DRX should be an integer multiple of the cycle length of the DTX/DRX of the PCell) and/or to satisfy the requirements for alignment of the starting position (e.g., the starting position of the UE DRX cycle should be within the duration of active state of the DTX/DRX of the PCell), and/or satisfy a duration alignment requirement (the duration of the active state of the UE DRX should be within the duration of the active state of the PCell DTX/DRX); or, the UE achieves the alignment between the UE DRX and the cell DTX/DRX of the PCell by using any of the above implementations.

Alternatively, in case the UE has a plurality of serving cells, the cell DTX and/or cell DRX associates with the primary secondary cells of the plurality of serving cells. That is, the UE DRX only needs to be aligned with the cell DTX/DRX of the primary secondary Cell (PSCell). The UE achieves the alignment between the UE DRX and the cell DTX/DRX of the primary secondary cell by using any of the above implementations.

Alternatively, a UE DRX only needs to be aligned with one cell DTX/DRX in the corresponding plurality of serving cells, and the cell DTX/DRX used for alignment with the UE DRX may be pre-configured by the network through high-layer signaling, or a cell corresponding to a preset index of one of the plurality of serving cells. Wherein the alignment method may be any of the above implementations.

Alternatively, to prevent alignment of the same UE DRX with different cell DTX/DRX configurations in the corresponding plurality of serving cells, the plurality of serving cells corresponding to the same UE DRX should share the same cell DTX/DRX configuration. The plurality of serving cells corresponding to the same UE DRX may also share the same control mechanism of cell DTX/DRX. Specifically, the plurality of serving cells is associated with the same state of cell DTX/DRX. The cell DTX/DRXs of the plurality of multiple serving cells are in an active or inactive state at the same time.

The periodic cell DTX/DRX is enabled dynamically. For example, the base station enables the periodic cell DTX/DRX by means of the DCI, and the starting position of the enabled cell DTX/DRX cycle is a first time unit after satisfying a first preset interval following the time unit in which the DCI is located. A time unit may be a symbol or a time slot. The DCI may indicate a cycle length, and/or onDuration length of the enabled cell DTX/DRX. For example, the base station pre-configures a plurality of cycle lengths of the cell DTX/DRX by high-layer signaling (e.g., RRC signaling), and the DCI indicates one of the lengths as a cycle length of the enabled cell DTX/DRX. The base station also pre-configures a plurality of onDuration lengths of the cell DTX/DRX by high-layer signaling (e.g., RRC signaling), and the DCI indicates one of them as the onDuration length of the enabled cell DTX/DRX.

The cell DTX/DRX may be aperiodic.

The aperiodic cell DTX/DRX is dynamically enabled, and the aperiodic cell DTX/DRX indicates that the cell DTX/DRX is not periodic. The base station may dynamically indicate that the cell DTX/DRX is about to enter an inactive state and last for a certain period of time, or indicate that the cell DTX/DRX is about to enter an active state and last for a certain period of time. For example, the base station indicates via the DCI that the cell DTX/DRX is about to enter an inactive state (i.e., a dormant state) for a period of time, at the end of which the cell re-enters a normal state (i.e., a state in which there are no transmit/receive constraints, such as an active state of the cell DTX/DRX). The starting time of the inactive state of the cell DTX/DRX indicated by the DCI is the first time unit (symbol or time slot) after satisfying a second preset interval following the time unit in which the DCI is located.

In an aperiodic cell DTX/DRX scheme, the following methods are possible for determining the duration length of the inactive state of the aperiodic cell DTX/DRX.
1. The inactive state duration length is determined by the periodic cell DTX/DRX configuration. That is, the duration length of the inactive state of the aperiodic cell DTX/DRX is the same as the duration length of the inactive state of the periodic cell DTX/DRX. The inactive state duration length is the difference between the cycle length of the cell DTX/DRX and the duration length of the active state.
2. The inactive state duration length is specifically configured by high-layer signaling. That is, the duration length of the inactive state of the aperiodic cell DTX/DRX is configured by UE-specific RRC signaling.
3. The inactive state duration length is indicated by the DCI, e.g., a plurality of candidate lengths is pre-configured by high-layer signaling, and one of the plurality of candidate lengths is indicated as the duration length by the DCI.

Alternatively, the system supports both the periodic cell DTX/DRX and aperiodic cell DTX/DRX, but both cannot be enabled at the same time, which causes the system to be easier to implement. Alternatively, the system can activate both the periodic cell DTX/DRX and the aperiodic cell DTX/DRX at the same time. That is, when the periodic cell DTX/DRX is enabled, the base station can also indicate the aperiodic cell DTX/DRX by the DCI. Thus, within the active state duration of the periodic cell DTX/DRX, the base station may indicate by the DCI that the cell DTX/DRX is about to enter an inactive state and last for a period of time, at the end of which the cell may still be in the active state of the current cycle of the periodic cell DTX/DRX, may be in the inactive state of the current cycle of the periodic cell DTX/DRX, or may be in the active state or an inactive state of the next cycle of the periodic cell DTX/DRX.

The preset interval referred to herein, including the first preset interval and the second preset interval, may be determined by one of the following methods.

1. The size of the preset interval is predefined, e.g., fixed to N_{U} symbols or N_{U} time slots, N_{U} is a positive integer.

2. The size of the preset interval is pre-configured by high-layer signaling, e.g., the size of the preset interval is configured by the base station through UE-specific RRC signaling, or, the size of the preset interval is indicated by the base station through system information.

3. The size of the preset interval is indicated by the DCI, e.g., the base station configures a plurality of values of the preset interval by RRC signaling, and then indicates one of them as the size of the preset interval by the DCI, i.e., the DCI used for activating the periodic cell DTX/DRX or the aperiodic cell DTX/DRX also includes a field for indicating the size of the preset interval.

4. The preset interval includes two parts, wherein the size of the first part is predefined, and the size of the second part is pre-configured by high-layer signaling, or indicated by the DCI; alternatively, the size of the first part is pre-configured by high-layer signaling, and the size of the second part is indicated by the DCI.

5. The preset interval includes three portions, the size of the first part is predefined, the size of the second part is pre-configured by high-layer signaling, and the size of the third part is indicated by the DCI.

The DCI for activating a periodic cell DTX/DRX, and the DCI for activating a aperiodic cell DTX/DRX, may have at least one of the following possibilities.

1. Adding an indication field to an existing UE-specific DCI format for data scheduling used for activating the periodic cell DTX/DRX or the aperiodic cell DTX/DRX, i.e., the cyclic redundancy check (CRC) of the DCI is scrambled by C-RNTI, and the data scheduling includes uplink scheduling, downlink scheduling and/or bypass scheduling, for example.

2. The DCI is a UE group common DCI. The DCI is scrambled by means of a dedicated RNTI value, e.g., by adding an indication field to an existing UE group common DCI for activating the periodic cell DTX/DRX or the aperiodic cell DTX/DRX, or by defining a new UE group common DCI format, which includes an indication field for activating the periodic cell DTX/DRX or the aperiodic cell DTX/DRX.

Herein, the UE needs to feedback an ACKnowledge (ACK) character for the above DCI for activating the periodic or aperiodic cell DTX/DRX to report to the base station that the DCI has been successfully received so as to avoid inconsistency in identifying the state of the cell DTX/DRX between the base station and the UE.

In an inactive state of the cell DTX/DRX, the periodic channel state information-reference signal (CSI-RS), the semi-persistent CSI-RS and the aperiodic CSI-RS are not transmitted, corresponding to which the UE cannot receive the CSI-RS, which affects the CSI-RS-based measurements of the UE for at least radio resource management (RRM), radio link monitoring (RLM), and beam management (BM). For a UE in the RRC connection state, these measurements may be configured as the CSI-RS-based measurements, and when the UE is configured with CSI-RS based measurement events and with periodic cell DTX/DRX, the UE may perform the measurements by at least one of the following methods:

1. The UE autonomously realizes to receive CSI-RS in the active state of the periodic cell DTX/DRX as much as possible. Each measurement of the measurement event that is configured to be based on CSI-RS is based on the CSI-RS, and the base station shall ensure that the UE, during each measurement cycle, receives the CSI-RS at least one time, when configuring the periodic cell DTX/DRX, and periodic/semi-persistent CSI-RS. In other words, the base station ensures that the cell DTX/DRX is active for at least one cycle of time during each measurement cycle of the UE, to transmit the CSI-RS for UE measurement.

2. Due to the effect of the cell DTX/DRX inactive state on the CSI-RS transmission, the CSI-RS based measurement behavior of the UE may be relaxed. That is, if the UE is unable to receive the CSI-RS to perform the measurement during a measurement cycle, the UE may skip the measurement cycle. Thus, the measurement events that are configured to be based on CSI-RS of certain measurements can be skipped, and the system may predefine or pre-configure the number of maximum consecutively skippable measurement periods for the UE.

3. If the point in time at which the UE intends to perform the measurement is in an inactive state of the cell DTX/DRX, then the UE may perform the measurement based on the synchronization signal block (SSB) associated with the CSI-RS that was originally to be received, since the transmission of the SSB is not affected by the inactive state of the cell DTX/DRX and the base station always transmits the SSB. In other words, some measurement samples of the measurement events configured to be based on the CSI-RS may be based on the SSB, the CSI-RS and its associated SSB correspond to the same beam direction and have a Quasi Co-located (QCL) relationship. In addition, the base station may configure a power offset for the CSI-RS relative to the SSB, and the UE adjusts the SSB-based measurement results based on the power offset accordingly. The adjusted SSB-based measurement results and the CSI-RS-based measurement results are comparable.

Herein, whether the periodic CSI-RS, the semi-persistent CSI-RS can be transmitted in the inactive state of the cell DTX/DRX is configurable, e.g., the base station indicates, based on the configuration of each CSI-RS, whether the corresponding CSI-RS can be transmitted in the inactive state of the cell DTX/DRX.

A method performed by a base station in a communication system includes transmitting to a UE a first configuration for receiving a DRX, the first configuration including at least one of a first starting position, a first cycle length and a first onDuration length to enable the UE to perform the DRX based on the first configuration.

After the cell DTX and/or cell DRX is enabled, a second configuration of the DRX is determined by the UE, the second configuration including at least one of a second starting position, a second cycle length and a second onDuration length to enable the UE to perform the DRX based on the second configuration.

Wherein the first starting position and the second starting position are different, and/or, the first cycle length and the second cycle length are different, and/or, the first onDuration length and the second onDuration length are different.

The second starting position of the DRX is determined to be the starting position of the cell DTX and/or cell DRX.

Alternatively, the second starting position of the DRX is determined to be one of a plurality of preset positions within the onDuration of the cell DTX and/or cell DRX, wherein the plurality of preset positions within the onDuration of the cell DTX and/or cell DRX have the same interval.

The second starting position of the DRX is determined as the i+1st preset position within the onDuration of the cell DTX and/or cell DRX based on the following Equation (6), according to the number N of preset positions within the onDuration of the cell DTX and/or cell DRX and the preset parameter.

$$i = ( parameter ) \% N \qquad ( 6 )$$

In Equation (6), the first preset position within the onDuration of the cell DTX and/or cell DRX is a starting position of the cell DTX and/or cell DRX.

The method further includes the transmitting to the UE a position index of one of the plurality of preset positions indicated by the MAC CE or DCI to enable the UE to use the preset position corresponding to the position index as the second starting position of the DRX.

The interval between the neighboring preset positions within the onDuration of the cell DTX and/or cell DRX is determined in at least one of the following manners:

The interval is pre-configured by high-layer signaling.

The interval is a first onDuration length of the DRX.

The interval is a second onDuration length of the DRX.

The number of preset positions within the onDuration of the cell DTX and/or cell DRX is determined in at least one of the following manners:

The number of preset positions is pre-configured by high-layer signaling.

The number of preset positions is determining according to a ratio of a onDuration length of the cell DTX and/or cell DRX to a first onDuration length of the DRX.

The number of preset positions is determined according to a ratio of a onDuration length of the cell DTX and/or cell DRX to a second onDuration length of the DRX.

The preset parameter is pre-configured by high-layer signaling, or, the preset parameter is determined based on at least one of:
a cell radio network temporary identity C-RNTI value of the UE,
a UE identity value of the UE,
a temporary mobile station identity TMSI value of the UE, and
an international mobile station identity IMSI value of the UE.

The second cycle length of the DRX is determined as a cycle length of the cell DTX and/or cell DRX or based on the cycle length of the cell DTX and/or cell DRX, and the first cycle length of the DRX.

The second cycle length of the DRX is determined based on at least one of the following formulas:

┌T_{ue_drx}/T_{cell_dtxdrx}┐*T_{cell_dtxdrx}

└T_{ue_drx}/T_{cell_dtxdrx}┘*T_{cell_dtxdrx},

wherein T_{cell_dtxdrx} is a cycle length of the cell DTX and/or cell DRX, T_{ue_drx} is a first cycle length of the DRX, ┌·┐ is an upward rounded integer, and └·┘ is a downward rounded integer.

The second onDuration length of the DRX is determined as the onDuration length of the cell DTX and/or cell DRX or based on a ratio of the onDuration length of the cell DTX and/or cell DRX to M, M is a positive integer, the value of M is predefined or pre-configured.

The second configuration of the DRX is indicated by RRC signaling.

The DRX is performed by default based on the second DRX configuration of the DRX after the cell discontinuous transmission DTX and/or the cell DRX is enabled or based on the first configuration or the second configuration or the DRX, which is indicated by first information, the first information is carried by the MAC CE or DCI.

The method further includes transmitting to the UE the second information related to the DRX, indicated by the MAC CE or DCI, to enable the UE to determine the second configuration of the DRX based on the second information.

The second information is used to indicate at least one of an offset of a second starting position of the DRX relative to a first starting position of the DRX, a second cycle length of the DRX, or a second onDuration length of the DRX.

The MAC CE or DCI further includes a field for activating the configuration of the cell DTX and/or cell DRX.

The second configuration of the DRX is determined in at least one of the following cases:
during at least one cycle of the DRX, a first starting position of the DRX is outside a onDuration of the cell DTX and/or cell DRX,
during the at least one cycle of the DRX, a length of overlap of the first onDuration of the DRX and the onDuration of the cell DTX and/or cell DRX is less than a preset time length, or
during the at least one cycle of the DRX, the first onDuration of the DRX has no overlap with the onDuration of the cell DTX and/or cell DRX.

The second cycle length of the DRX is an integer multiple of the cycle length of the cell DTX and/or cell DRX, and/or
the second starting position of the DRX is within the onDuration of the cell DTX and/or cell DRX, and/or
the second onDuration of the DRX is within the onDuration of the cell DTX and/or cell DRX.

If the UE has a plurality of serving cells, the cell DTX and/or cell DRX associates with at least one of the following cells:
a PCell of among plurality of serving cells,
a primary secondary cell among a plurality of serving cells,
a cell corresponding to a preset index among a plurality of serving cells, or
a cell pre-configured by high-layer signaling among a plurality of serving cells.

The plurality of serving cells associates with a same DRX configuration.

The method performed by the base station of each embodiment of the disclosure corresponds to the method of each embodiment at the UE side, and the detailed functional description and the beneficial effect produced thereof can be specifically referred to in the description in the corresponding method shown in each embodiment at the UE side in the preceding section, and will not be repeated herein.

In accordance with an aspect of the disclosure, a method performed by a UE in a communication system includes receiving a first configuration of a discontinuous reception (DRX), the first configuration including at least one of a first starting position, a first cycle length and a first onDuration length, performing the DRX based on the first configuration, determining a second configuration of the DRX after a cell discontinuous transmission (DTX) and/or cell DRX is enabled, the second configuration including at least one of a second starting position, a second cycle length and a second onDuration length, and performing the DRX based on the second configuration. Optionally, the first starting position and the second starting position are different, and/or, the first cycle length and the second cycle length are different, and/or, the first onDuration length and the second onDuration length are different.

Optionally, the determining the second starting position of the DRX includes at least one of the following:
determining a starting position of the cell DTX and/or cell DTX as the second starting position of the DRX;
determining one of a plurality of preset positions within the onDuration of the cell DTX and/or cell DRX as the second starting position of the DRX, wherein the neighboring preset positions within the onDuration of the cell DTX and/or cell DRX have a same interval.

Optionally, the determining one of the plurality of preset positions within the onDuration of the cell DTX and/or cell DRX as the second starting position of the DRX includes:
determining the i+1st preset position within the onDuration of the cell DTX and/or cell DRX as the second starting position of the DRX, according to the number N of preset positions within the onDuration of the cell DTX and/or cell DRX, and a preset parameter, based on the following formula:

$$i = ( parameter ) \% N ,$$

wherein the first preset position within the onDuration of the cell DTX and/or cell DRX is a starting position of the cell DTX and/or cell DRX.

Optionally, the determining one of the plurality of preset positions within the onDuration of the cell DTX and/or cell DRX as the second starting position of the DRX includes:
receiving a position index of one of the plurality of preset positions indicated by a media access control (MAC) control element (CE) or downlink control information (DCI);
using a preset position corresponding to the position index as the second starting position of the DRX.

Optionally, the interval between the neighboring preset positions within the onDuration of the cell DTX and/or cell DRX is determined in at least one of the following ways:
pre-configured by high-layer signaling;
the interval is a first onDuration length of the DRX;
the interval is a second onDuration length of the DRX.

Optionally, the number of preset positions within the onDuration of the cell DTX and/or cell DRX is determined in at least one of the following ways:
pre-configured by high-layer signaling;
determining according to a ratio of a onDuration length of the cell DTX and/or cell DRX to a first onDuration length of the DRX;
determining according to a ratio of a onDuration length of the cell DTX and/or cell DRX to a second onDuration length of the DRX.

Optionally, the preset parameter is pre-configured by high-layer signaling, or, the preset parameter is determined based on at least one of:
a cell radio network temporary identity (C-RNTI) value of the UE;
a UE identity value of the UE;
a temporary mobile station identity (TMSI) value of the UE;
an international mobile station identity (IMSI) value of the UE.

Optionally, the determining the second cycle length of the DRX includes at least one of the following ways:
determining a cycle length of the cell DTX and/or cell DRX as the second cycle length of the DRX;
determining the second cycle length of the DRX according to the cycle length of the cell DTX and/or cell DRX, and the first cycle length of the DRX.

Optionally, the determining the second cycle length of the DRX according to the cycle length of the cell DTX and/or cell DRX, and the first cycle length of the DRX, includes:

determining the second cycle length of the DRX based on at least one of the following formulas:

┌T_{ue_drx}/T_{cell_dtxdrx}┐*T_{cell_dtxdrx}

└T_{ue_drx}/T_{cell_dtxdrx}┘*T_{cell_dtxdrx},

wherein T_{cell_dtxdrx} is a cycle length of the cell DTX and/or cell DRX, T_{ue_drx} is a first cycle length of the DRX, ┌·┐ is an upward rounded integer, and └·┘ is downward rounded integer.

Optionally, the determining the second onDuration length of the DRX includes at least one of the following:
determining a onDuration length of the cell DTX and/or cell DRX as the second onDuration length of the DRX;
determining the second onDuration length of the DRX according to a ratio of the onDuration length of the cell DTX and/or cell DRX to M, M is a positive integer, the value of M is predefined or pre-configured.

Optionally, the determining the second configuration of the DRX, includes: receiving the second configuration of the DRX indicated by radio resource control (RRC) signaling.

Optionally, after the DTX and/or the cell DRX is enabled, the method further includes at least one of the following items:
performing the DRX based on the second configuration by default;
receiving first information of application of the first configuration or the second configuration indicated by the MAC CE or DCI, and performing the DRX based on the DRX configuration corresponding to the first information.

Optionally, the determining the second configuration of the DRX, includes:
receiving second information related to the DRX indicated by the MAC CE or DCI;
determining the second configuration of the DRX based on the second information.

Optionally, the second information is used to indicate at least one of the following:
an offset of a second starting position of the DRX relative to a first starting position of the DRX;
a second cycle length of the DRX;
a second onDuration length of the DRX.

Optionally, the MAC CE or DCI further includes a field for activating the configuration of the cell DTX and/or cell DRX.

Optionally, the determining the second configuration of the DRX, includes:
determining the second configuration of the DRX in at least one of the following cases:
during at least one cycle of the DRX, a first starting position of the DRX is outside a onDuration of the cell DTX and/or cell DRX;
during the at least one cycle of the DRX, a length of overlap of the first onDuration of the DRX and the onDuration of the cell DTX and/or cell DRX is less than a preset time length;
during the at least one cycle of the DRX, the first onDuration of the DRX has no overlap with the onDuration of the cell DTX and/or cell DRX.

Optionally, the second cycle length of the DRX is an integer multiple of the cycle length of the cell DTX and/or cell DRX; and/or,
the second starting position of the DRX is within the onDuration of the cell DTX and/or cell DRX; and/or,
the second onDuration of the DRX is within the onDuration of the cell DTX and/or cell DRX.

Optionally, in case the UE has a plurality of serving cells, the cell DTX and/or cell DRX associates with at least one of the following cells:
a primary cell among a plurality of serving cells;
a primary secondary cell among a plurality of serving cells;
a cell corresponding to a preset index among a plurality of serving cells;
a cell pre-configured by high-layer signaling among a plurality of serving cells.

Optionally, the plurality of serving cells associate with a same DRX configuration.

In accordance with an aspect of the disclosure, a method performed by a base station in a communication system includes transmitting to a UE a first configuration for receiving a DRX, the first configuration including at least one of a first starting position, a first cycle length and a first onDuration length to enable the UE to perform the DRX based on the first configuration; after the cell and/or cell DRX is enabled, determining a second configuration of the DRX, the second configuration including at least one of a second starting position, a second cycle length and a second onDuration length, and performing the DRX based on the second configuration.

In accordance with an aspect of the disclosure, a user equipment includes a transceiver, and a processor, which is coupled to the transceiver and configured to perform the method of receiving a first configuration of a discontinuous reception (DRX), the first configuration including at least one of a first starting position, a first cycle length and a first onDuration length, performing the DRX based on the first configuration, determining a second configuration of the DRX after a cell discontinuous transmission (DTX) and/or cell DRX is enabled, the second configuration including at least one of a second starting position, a second cycle length and a second onDuration length, and performing the DRX based on the second configuration.

In accordance with an aspect of the disclosure, a base station includes a transceiver, and a processor, which is coupled to the transceiver and configured to perform the method performed by the base station according to an embodiment of the disclosure.

According to a still further aspect of embodiments of the disclosure, there is provided a computer-readable storage medium having stored computer programs thereon, the computer programs is performed by the processor to implement the method performed by the UE according to an embodiment of the disclosure.

According to a still further aspect of an embodiment of the disclosure, there is provided a computer-readable storage medium having computer programs stored thereon, the computer programs when performed by the processor implement a method performed by the base station according to an embodiment of the disclosure.

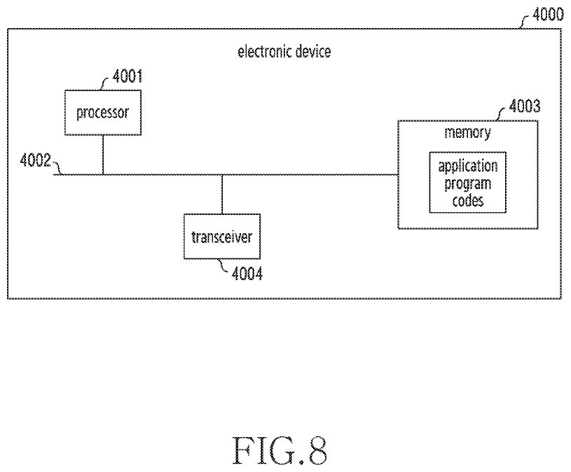

FIG. 8 illustrates an electronic device to which an embodiment of the present invention is applicable.

In FIG. 8, an electronic device 4000 disclosed herein includes a transceiver 4004 configured to transmit and receive signals, and a processor 4001 coupled to the transceiver 4004 and configured to realize the steps of each of the preceding method embodiments. The electronic device 4000 may refer to a UE, then the processor is configured to realize the steps of the respective method embodiments performed by the UE, a detailed functional description and the resulting beneficial effect of which may be specifically described in the preceding description in the respective method embodiments performed by the UE, and which will not be repeated herein. Alternatively, the electronic device may refer to a base station, then the processor is configured to realize the steps of the aforementioned method embodiments performed by the base station, the detailed functional description and the resulting beneficial effects of which may be specifically referred to in the description of the respective method embodiments performed by the base station in the preceding text and will not be repeated herein. In practice, the UE or the base station may be understood as different network nodes.

Embodiments of the disclosure also provide an electronic device including a processor, optionally further including a transceiver and/or a memory coupled to the processor, the processor is configured to perform the steps of the method provided in any optional embodiment of the disclosure.

In FIG. 8, the electronic device 4000 in FIG. 8 includes a processor 4001 and a memory 4003. The processor 4001 is connected to the memory 4003, for example, through a bus 4002. The electronic device 4000 may further include a transceiver 4004, and the transceiver 4004 may be used for data interaction between the electronic device and other electronic devices, such as data transmission and/or data reception. In practical applications, the number of the transceiver 4004 is not limited to one, and the structure of the electronic device 4000 does not constitute any limitation to the embodiments of the disclosure. The electronic device may be a first network node, a second network node or a third network node.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It is possible to implement or perform the various exemplary logical blocks, modules and circuits described in combination with the disclosures of the present disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 8. However, there may be at least one additional bus or type of bus.

The memory 4003 may be a ROM or other types of static storage devices that can store static information and instructions, a RAM or other types of dynamic storage devices that can store information and instructions, and can also be electrically erasable programmable read only memory (EEPROM), compact disc read only memory (CD-ROM) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation.

The memory 4003 is used to store computer programs for performing embodiments of the disclosure and is controlled for execution by the processor 4001. The processor 4001 is configured to perform the computer programs stored in the memory 4003 to implement the steps shown in the foregoing method embodiments.

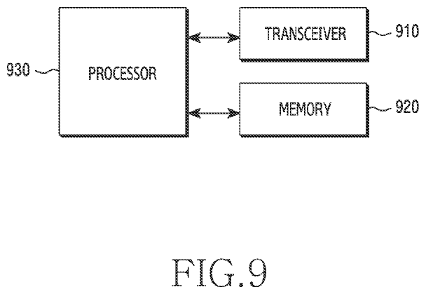

FIG. 9 illustrates a structure of a UE according to an embodiment.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor. Furthermore, the UE of FIG. 9 corresponds to the electronic device of FIG. 8. The UE of FIG. 9 corresponds to the UE of FIG. 3A.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

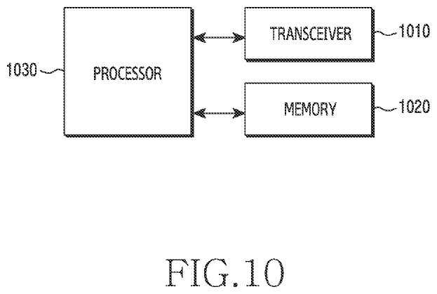

FIG. 10 illustrates a structure of a base station according to an embodiment.

As shown in FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. Also, the processor 1030 may include at least one processor. Furthermore, the base station of FIG. 10 corresponds to the electronic device of the FIG. 8. The base station of FIG. 10 corresponds to the base station of the FIG. 3B.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

Embodiments of the disclosure provide a computer-readable storage medium having a computer program stored on the computer-readable storage medium, the computer program, when performed by a processor, implements the steps and corresponding contents of the foregoing methods.

Embodiments of the disclosure also provide a computer program product including a computer program, the computer program when performed by a processor realizing the steps and corresponding contents of the preceding method embodiments.

It should be understood that, although various operational steps are indicated by arrows in the flowcharts of embodiments of the disclosure, the order in which the steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be performed at the same moment, and each of these sub-steps or stages can also be performed at different moments separately. The order of execution of these sub-steps or stages can be flexibly configured according to requirements in different scenarios of execution time, and the embodiments of the disclosure are not limited thereto.

While this disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a communication system, the method comprising:
receiving a first configuration of a discontinuous reception (DRX), the first configuration including at least one of a first starting position, a first cycle length and a first onDuration length;
performing the DRX based on the first configuration;
determining a second configuration of the DRX after a cell discontinuous transmission (DTX) and/or cell DRX is enabled, the second configuration including at least one of a second starting position, a second cycle length and a second onDuration length; and
performing the DRX based on the second configuration.

2. The method according to claim 1,
wherein the first starting position and the second starting position are different, and/or, the first cycle length and the second cycle length are different, and/or, the first onDuration length and the second onDuration length are different.

3. The method according to claim 2,
wherein determining the second starting position of the DRX comprises at least one of the following:
determining the starting position of the cell DTX and/or cell DTX as the second starting position of the DRX; and
determining one of a plurality of preset positions within a onDuration of the cell DTX and/or cell DRX as the second starting position of the DRX,
wherein neighboring preset positions within the onDuration of the cell DTX and/or cell DRX have an identical interval.

4. The method according to claim 3,
wherein determining one of the plurality of preset positions within the onDuration of the cell DTX and/or cell DRX as the second starting position of the DRX comprises:
determining an i+1st preset position within the onDuration of the cell DTX and/or cell DRX as the second starting position of the DRX, according to a number N of preset positions within the onDuration of the cell DTX and/or cell DRX, and a preset parameter, based on the following Equation:
$$i = ( parameter ) \% N ,$$
wherein the first preset position within the onDuration of the cell DTX and/or cell DRX is the starting position of the cell DTX and/or cell DRX.

5. The method according to claim 3,
wherein determining one of a plurality of preset positions within the onDuration of the cell DTX and/or cell DRX as the second starting position of the DRX comprises:
receiving a position index of one of the plurality of preset positions indicated by a media access control (MAC) control element (CE) or downlink control information (DCI); and
using a preset position corresponding to the position index as the second starting position of the DRX.

6. The method according to claim 5,
wherein the interval between the neighboring preset positions within the onDuration of the cell DTX and/or cell DRX is determined by at least one of being
pre-configured by high-layer signaling, being a first onDuration length of the DRX, or being a second onDuration length of the DRX.

7. The method according to claim 5,
wherein the number of preset positions within the onDuration of the cell DTX and/or cell DRX is determined by at least one of being pre-configured by high-layer signaling, a ratio of an onDuration length of the cell DTX and/or cell DRX to a first onDuration length of the DRX, or a ratio of the onDuration length of the cell DTX and/or cell DRX to a second onDuration length of the DRX.

8. The method according to claim 4,
wherein the preset parameter is pre-configured by high-layer signaling, or
wherein the preset parameter is determined based on at least one of:
a cell radio network temporary identity (C-RNTI) value of the UE,
a UE identity value of the UE,
a temporary mobile station identity (TMSI) value of the UE, or
an international mobile station identity (IMSI) value of the UE.

9. The method according to claim 2,
wherein the second cycle length of the DRX is determined based on at least one of the following:
determining the cycle length of the cell DTX and/or cell DRX as the second cycle length of the DRX; or
determining the second cycle length of the DRX according to the cycle length of the cell DTX and/or cell DRX, and the first cycle length of the DRX.

10. The method according to claim 9,
wherein the second cycle length of the DRX is determined according to the cycle length of the cell DTX and/or cell DRX, and the first cycle length of the DRX, comprises:
determining the second cycle length of the DRX based on at least one of the following formulas:
┌T_{ue_drx}/T_{cell_dtxdrx}┐*T_{cell_dtxdrx}
└T_{ue_drx}/T_{cell_dtxdrx}┘*T_{cell_dtxdrx},
wherein, T_{cell_dtxdrx} is a cycle length of the cell DTX and/or cell DRX, T_{ue_drx} is a first cycle length of the DRX, ┌·┐ is an upwardly rounded integer, and └·┘ is a downwardly rounded integer.

11. The method according to claim 2,
wherein the second onDuration length of the DRX is determined based on at least one of the following:
determining the onDuration length of the cell DTX and/or cell DRX as the second onDuration length of the DRX; or
determining the second onDuration length of the DRX according to a ratio of the onDuration length of the cell DTX and/or cell DRX to M,
wherein M is a positive integer and the value of M is predefined or pre-configured.

12. The method according to claim 11,
wherein determining the second configuration of the DRX comprises receiving the second configuration of the DRX indicated by radio resource control (RRC) signaling.

13. The method according to claim 2,
wherein determining the second configuration of the DRX comprises:
receiving second information relating to the DRX indicated by a media access control (MAC) control element (CE) or downlink control information (DCI); and
determining the second configuration of the DRX based on the second information.

14. The method according to claim 13,
wherein the second information is used to indicate at least one of:
an offset of a second starting position of the DRX relative to a first starting position of the DRX,
a second cycle length of the DRX, or
a second onDuration length of the DRX.

15. The method according to claim 13,
wherein the MAC CE or DCI further comprises a field for activating the configuration of the cell DTX and/or cell DRX.

16. The method according to claim 2,
wherein the second configuration of the DRX is determined in at least one of the following cases:
during at least one cycle of the DRX, a first starting position of the DRX is outside the onDuration length of the cell DTX and/or cell DRX;
during at least one cycle of the DRX, a length of overlap of the first onDuration of the DRX with the onDuration of the cell DTX and/or cell DRX is less than a preset time length; or
during at least one cycle of the DRX, the first onDuration of the DRX does not overlap with the onDuration of the cell DTX and/or cell DRX.

17. The method according to claim 16,
wherein the second cycle length of the DRX is an integer multiple of the cycle length of the cell DTX and/or cell DRX,
wherein the second starting position of the DRX is within the onDuration of the cell DTX and/or cell DRX, or
wherein the second onDuration of the DRX is within the onDuration of the cell DTX and/or cell DRX.

18. The method according to claim 17,
wherein in case the UE has a plurality of serving cells, the cell DTX and/or cell DRX associates with at least one of:
a primary cell among the plurality of serving cells,
a primary secondary cell among the plurality of serving cells,
a cell corresponding to a preset index among the plurality of serving cells, or
a cell pre-configured by high-layer signaling among the plurality of serving cells.

19. The method according to claim 18,
wherein the plurality of serving cells associates with a same DRX configuration.

20. A user equipment, comprising:
a transceiver, and
a processor, which is coupled to the transceiver and configured to perform a method of:
receiving a first configuration of a discontinuous reception (DRX), the first configuration including at least one of a first starting position, a first cycle length and a first onDuration length;
performing the DRX based on the first configuration;
determining a second configuration of the DRX after a cell discontinuous transmission (DTX) and/or cell DRX is enabled, the second configuration including at least one of a second starting position, a second cycle length and a second onDuration length; and
performing the DRX based on the second configuration.
